(19) United States
(12) Patent Application Publication
(10) Pub. No.: US 2025/0385584 A1
(43) Pub. Date: Dec. 18, 2025

(54) Linear Motor

(71) Applicant: AAC Microtech (Changzhou) Co., Ltd., Changzhou City (CN)

(72) Inventors: Peng Cai, Changzhou (CN); Junsheng Wang, Changzhou (CN); Jie Wu, Changzhou (CN); Fali Zhong, Changzhou (CN)

(21) Appl. No.: 19/006,321

(22) Filed: Dec. 31, 2024

Related U.S. Application Data
(63) Continuation of application No. PCT/CN2024/099719, filed on Jun. 18, 2024.

(51) Int. Cl. H02K 33/18

(52) U.S. Cl. CPC H02K 33/18

(57) ABSTRACT

The present invention provides a linear motor having a housing with an accommodating cavity, a vibrator component and a stator component accommodated in the accommodating cavity. The stator component includes a guiding member and a coil unit for driving the vibrator component to reciprocate along a first direction. The vibrator component includes a magnet component having at least two magnets with magnetization directions opposite to each other. The stator component further includes auxiliary magnet components to form magnetic repulsion forces. The present invention replaces the traditional spring with a magnetic spring that forms a magnetic repulsion force between the magnets, improving the vibration performance and reliability of the linear motor

### TECHNICAL FIELD

This invention relates to the field of motors, specifically involving a linear motor used in an electronic device.

### BACKGROUND

With the development of science and technology and the progress of society, portable electronic products such as mobile phones, handheld game consoles, navigation devices, or handheld multimedia entertainment devices are widely used in people's daily lives. In some scenarios of using these electronic products, such as phone call alerts, message alerts, navigation prompts, and vibration feedback in game consoles, are generally achieved through linear motors.

The related linear motor adopts a spring to connect the oscillator to form a vibration system. However, the spring undergoes deformation stress during motion, and the stress increases with the larger motion stroke. When it reaches the material's lifespan limit, the spring may break, leading to the failure of the vibration system.

Therefore, it is necessary to provide a linear motor without the traditional problem of stress deformation in spring materials.

### SUMMARY

One of the major objects of the present invention is to provide a linear motor to solve the technical problem of short lifespan of linear motors due to deformation stress of springs in the related art.

To achieve the above purpose, the present invention provides a linear motor comprising a housing with an accommodating cavity, a stator component and a vibrator component accommodated in the accommodating cavity. The stator component comprises a guiding member fixed to the housing for supporting the vibrator component, and a coil unit for driving the vibrator component to reciprocate in a first direction. The vibrator component comprises a magnet component arranged along the first direction. The magnet component comprising at least two magnets arranged along the first direction, each of the magnets being magnetized along the first direction and magnetization directions of adjacent two magnets being opposite to each other. The stator component further comprises an auxiliary magnet component positioned near to adjacent ends of the at least two adjacent magnets; the auxiliary magnet component is magnetized along a second direction perpendicular to the first direction and forms magnetic repulsion with the corresponding the at least two magnets.

As an improvement of the above-mentioned linear motor, the auxiliary magnet component comprises a pair of auxiliary magnets magnetized along the second direction and arranged on opposite sides of the vibrator component for forming magnetic repulsion with the at least two magnets; or, the auxiliary magnet components comprise two pairs of auxiliary magnets magnetized along the second direction and arranged on opposite sides of the vibrator component, for forming magnetic repulsion with the at least two magnets; or, the auxiliary magnet component is an annular magnet, with the second direction being radial to the annular magnet for forming a magnetic repulsion with the at least two magnets.

As an improvement of the above-mentioned linear motor, the coil unit locates around the adjacent ends of the at least two adjacent magnets, and the coil unit is arranged on one side or both sides of the auxiliary magnet components along the first direction.

As an improvement of the above-mentioned linear motor, the guiding member comprises two sleeves arranged along the first direction at two ends of the vibrator component, the sleeve includes a guiding channel passing therethrough, and the vibrator component is accommodated in the guiding channel and slidably connected to the sleeves.

As an improvement of the above-mentioned linear motor, the vibrator component further includes a clamp plate sleeved in the guide sleeve with a cavity, the magnet component is fixed on the clamp plate and accommodated in the cavity, and the clamp plate is slidably connected with the guide sleeve.

As an improvement of the above-mentioned linear motor, the guide sleeve further has an avoidance groove for avoiding an edge of the clamp plate.

As an improvement of the above-mentioned linear motor, the vibrator component further comprises counterweights fixed to the clamp plate and positioned at opposite ends of the magnet component; the counterweight includes a first portion located outside the accommodating cavity and a second portion inside the accommodating cavity; the first portion does not contact the guide sleeve, and the clamp plate abuts against the first portion; the second portion has a groove on a surface connected to the clamp plate, and the groove engages with the protrusion on the clamp plate.

As an improvement of the above-mentioned linear motor, the magnet components further include at least one soft magnetic body arranged along the first direction and between the at least two magnets, and an amount of the soft magnetic body is one less than an amount of the magnets.

As an improvement of the above-mentioned linear motor, the soft magnetic body comprises a first soft magnetic body corresponding to the auxiliary magnet component and a second soft magnetic body arranged corresponding to the coil unit; the first soft magnetic body is opposite to the auxiliary magnet component, and the second soft magnetic body is opposite to the coil unit.

As an improvement of the above-mentioned linear motor, the soft magnetic body is made of at least one material selected from carbon steel, iron-cobalt alloys, amorphous alloys, or nanocrystalline alloys.

The vibrator component of the present invention comprises a housing with a containment cavity, the vibrator component housed in the containment cavity, and a stator component. The stator component includes a guiding member fixed to the housing and supporting the vibrator component, and a coil unit that drives the vibrator component to reciprocate along a first direction. The vibrator component includes a magnet component arranged along the first direction, which includes at least two magnets arranged along the first direction, each magnet magnetized along the first direction and with opposite magnetization directions between adjacent magnets. The stator component includes an auxiliary magnet component located at the adjacent ends of the adjacent two magnets, magnetized along a second direction perpendicular to the first direction, and forming magnetic repulsion with the corresponding two magnets.

By setting the auxiliary magnet component and the two parallel magnets with opposite magnetization directions as a magnetic spring, the magnetic repulsion between the auxiliary magnet component and the magnet provides an effective restoring force for the vibrator component, ensuring that the vibrator component can reciprocate along the first direction. This design not only solves the problem of deformation stress in traditional spring materials, improves the service life of the linear motor, but also does not occupy the design dimension of the first direction, allowing for a larger motion range and vibration amplitude of the vibrator component, enhancing vibration performance and reliability.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 is an isometric view of a linear motor in accordance with an exemplary embodiment of the present invention.

FIG. 2 is a cross-sectional view of the linear motor taken along line A-A in FIG. 1.

FIG. 3 is an exploded view of the linear motor in FIG. 1.

FIG. 4 is an exploded view of a vibrator component in the linear motor.

FIG. 5 is an isometric view of a linear motor in accordance with a first embodiment of the present invention, with an upper cover plate thereof removed.

FIG. 6 is an isometric view of a linear motor in accordance with a second embodiment of the present invention, with an upper cover plate thereof removed.

FIG. 7 is an isometric view of a linear motor in accordance with a third embodiment of the present invention, with an upper cover plate thereof removed.

FIG. 8 is a cross-sectional view of the linear motor taken along line B-B in FIG. 1.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

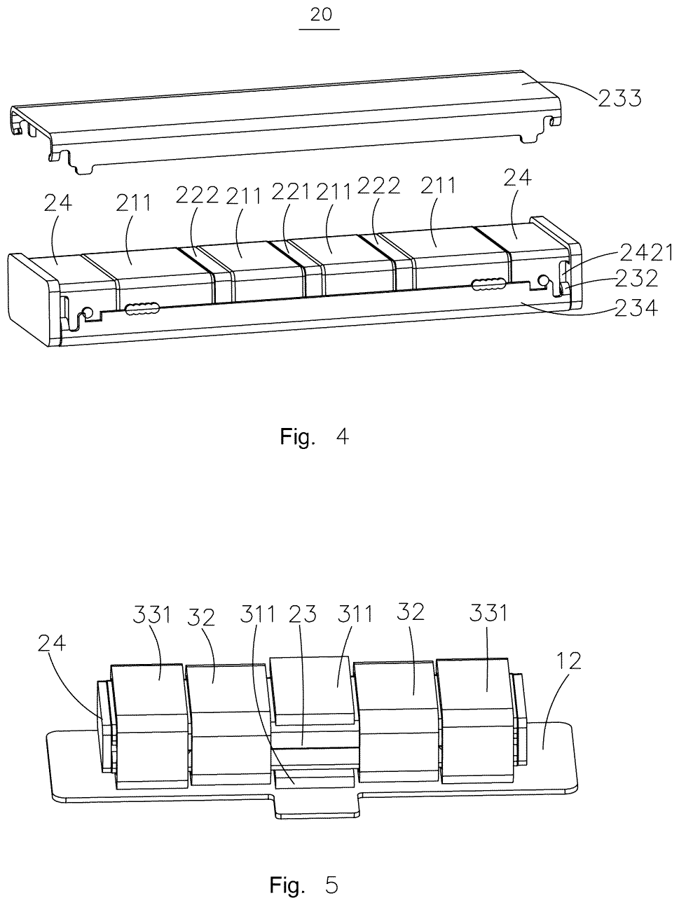

Please refer to FIGS. 1-8. The present invention provides a linear motor 100, comprising a housing 10 with an accommodating cavity 13, a vibrator component 20, and a stator component 30 accommodated in the accommodating cavity 13. The housing 10 includes an upper cover plate 11 and a bottom cover plate 12 which enclose the accommodating cavity. The stator component 30 includes a guiding member 33 fixed to the housing 10 and supporting the vibrator component 20, and a coil unit 32 driving the vibrator component 20 to reciprocate along the first direction X. The vibrator component 20 comprises a magnet component 21 arranged along the first direction X, the magnet component 21 includes at least two magnets 211 arranged along the first direction X, each magnet 211 is magnetized along the first direction X and the magnetization directions of adjacent two magnets 211 are opposite to each other.

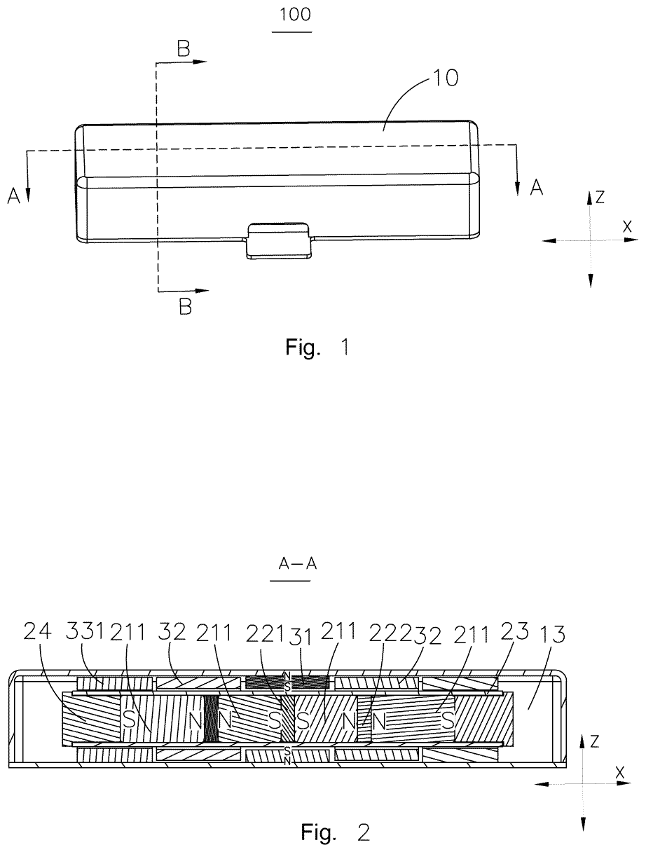

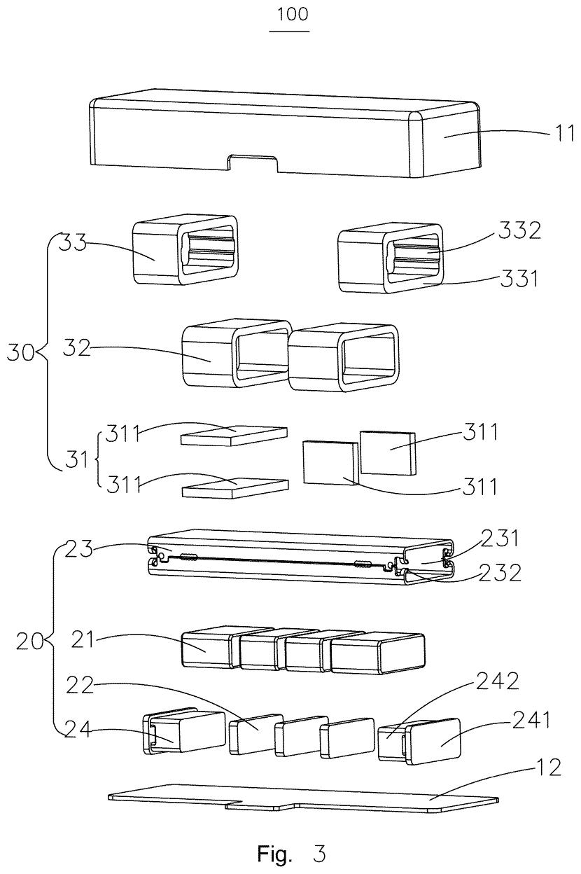

Please refer to FIG. 2 and FIG. 3 for details. The stator assembly 30 also includes auxiliary magnet components 31 set at the adjacent ends of two adjacent magnets 211. The auxiliary magnet components 31 are magnetized along the second direction Z perpendicular to the first direction X and generate magnetic repulsive forces with the corresponding two magnets 211 to provide effective restoring force for the vibrator component 20, ensuring that the vibrator component 20 can reciprocate along the first direction X. The auxiliary magnet components 31 cooperate with the corresponding two magnets 211 to form a magnetic spring system, replacing traditional motor springs. This not only solves the problems of large deformation stress and spring fracture during the movement of traditional motor springs, but also enhances the service life of the linear motor 100, increases the motion stroke of the linear motor 100, increases the vibration magnitude, and improves the vibration performance and reliability.

Please refer to FIGS. 5-7 for further details. The auxiliary magnet component 31 includes a pair of auxiliary magnets 311 magnetized in a second direction Z on opposite sides of the vibrator component 20, forming a magnetic repulsion with the corresponding two magnets 211; or the auxiliary magnet component 31 includes two pairs of auxiliary magnets 311 magnetized in a second direction Z on opposite sides of the vibrator component 20, forming a magnetic repulsion with the corresponding two magnets 211; or the auxiliary magnet component 31 is a ring-shaped magnet, with the second direction being the radial direction of the ring-shaped magnet, forming a magnetic repulsion with the corresponding two magnets 211.

Please refer to FIG. 2 and FIG. 5. The auxiliary magnet component 31 provided by the present invention can be a pair of auxiliary magnets 311 located on the upper and lower sides of the vibrator component 20, with both auxiliary magnets 311 magnetized along the upper and lower directions of the vibrator component 20 and the magnetization directions of the two auxiliary magnets 311 opposite to each other. At this time, the upper and lower directions of the vibrator component 20 are the second direction Z, and the two auxiliary magnets 311 generate magnetic repulsion with the corresponding magnet 211. The two auxiliary magnets 311 are symmetrically located on both sides of the magnet 211, allowing the magnet 211 to be more balanced and stable, further improving the stability of the linear motor 100.

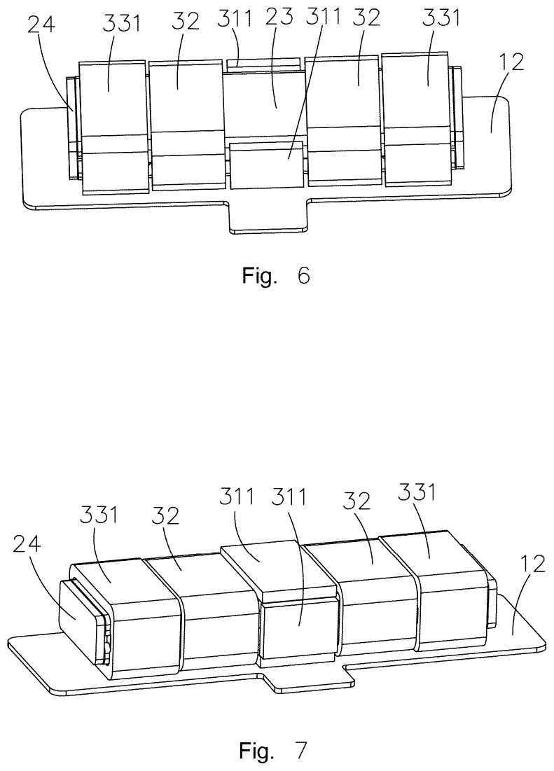

Please refer to FIG. 6, the auxiliary magnet components 31 provided by the present invention may be a pair of auxiliary magnets 311 located on the front and rear sides of the vibrator component 20, with both auxiliary magnet 311 magnetized along the front and rear directions of the vibrator component 20 and with opposite magnetization directions. At this time, the front and rear directions of the vibrator component 20 is the second direction Z, and the two auxiliary magnet 311 form a magnetic repulsion with the corresponding magnet 211; the two auxiliary magnet 311 are symmetrically placed on both sides of the magnet 211, making the magnet 211 more balanced and stable, further improving the stability of the linear motor 100.

Please refer to FIGS. 2 and 7. The auxiliary magnet component 31 provided by the present invention can consist of two pairs of auxiliary magnets 311 located on the upper and lower sides, as well as the front and back sides of the vibrator component 20. The two pairs of auxiliary magnet 311 are magnetized along the upper and lower directions and front and back directions of the vibrator component 20, with the magnetization directions of each pair of auxiliary magnet 311 being opposite to each other. At this time, the upper and lower directions and front and back directions of the vibrator component 20 are perpendicular to the oscillation direction of the vibrator component 20, namely the second direction Z. The four auxiliary magnet 311 pieces generate magnetic repulsion with the corresponding magnet 211 pieces. The four auxiliary magnet 311 pieces are symmetrically arranged around the upper and lower parts and front and back parts of the magnet 211, making the force applied to the magnet 211 more balanced and stable, thereby further improving the stability of the linear motor 100. Alternatively, the auxiliary magnet component 31 can be a ring-shaped magnet surrounding the vibrator component 20. The ring-shaped magnet is magnetized radially and generates magnetic repulsion with the corresponding magnet 211, with the second direction Z being the radial direction of the ring-shaped magnet.

Please refer to FIGS. 2-7. The coil unit 32 is wrapped around the adjacent ends of two adjacent magnets 211 to make the most of the magnetic field and generate greater driving force. The coil unit 32 has at least one and is set on one side or both sides of the auxiliary magnet component 31 along the first direction X. The coil unit 32, when energized, generates driving force in the magnetic field, thereby driving the vibrator component 20 to vibrate along the first direction X. The magnetic repulsive force between the auxiliary magnet component 31 and the corresponding magnet 211 provides a restoring force to the vibrator component 20, enabling the vibrator component 20 to reciprocate along the first direction X.

Further, please refer to FIGS. 5 to 7. The guiding member 33 includes two sleeves 331 positioned along the first direction X at the two ends of the vibrator component 20. The sleeves 331 are provided with guiding channels therethrough, wherein the vibrator component 20 is accommodated in the guiding channels and slidably connected to the sleeves 331. The two sleeves 331 are symmetrically arranged on both sides of the coil unit 32 along the first direction X, without increasing the size of the linear motor 100. Depending on actual conditions, the guiding member 33 can also be other guiding devices, such as guiding rods, sliding rails, or other structures capable of supporting the vibrator component 20, all of which fall within the scope of the present invention. The sleeves 331 can be made of wear-resistant materials such as plastic or alloy, or other wear-resistant materials.

Furthermore, please refer to FIGS. 2-7. The vibrator component 20 also includes a clamp plate 23 sleeved inside the guide sleeve 331 and having a cavity 231, the magnet component 21 is fixed on the clamp plate 23 and housed in the cavity 231, the clamp plate 23 is slidably connected with the guide sleeve 331. The clamp plate 23 includes an upper clamp plate 233 and a lower clamp plate 234 set opposite to the upper clamp plate 233, the upper clamp plate 233 and the lower clamp plate 234 jointly enclose the cavity 231; the clamp plate 23 is responsible for frictional contact with the guide sleeve 331, protecting the magnet component 21, thereby further increasing the service life of the linear motor 100. It should be noted that the clamp plate 23 can be made of non-magnetic material, and the clamp plate 23 can be integral, or as shown in this embodiment, formed by the combination of the upper clamp plate 233 and the lower clamp plate 234.

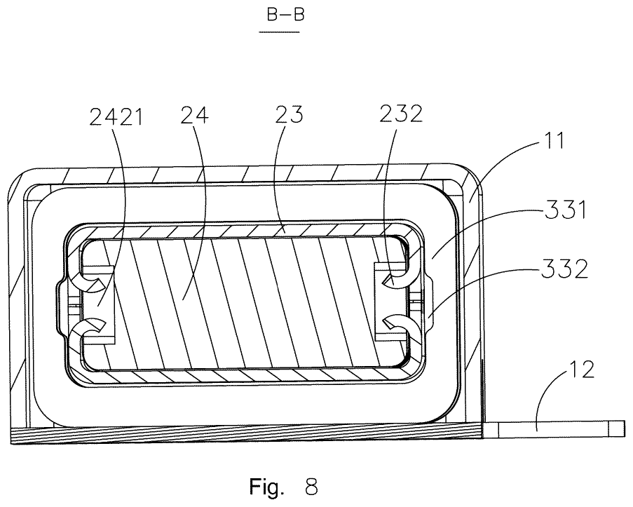

To reduce the friction between the clamp plate 23 and the sleeve 331, refer to FIG. 3 and FIG. 8, where the sleeve 331 is also provided with an avoidance groove 332 to avoid the edges of the clamp plate 23. The edges of the upper clamp plate 233 and the lower clamp plate 234 may have burrs, and the surface of the weld points during the welding of the upper clamp plate 233 and the lower clamp plate 234 may be rough and uneven. The setting of the avoidance groove 332 can prevent these burrs and rough surfaces from increasing the sliding friction between the vibrator component 20 and the sleeve 331, thereby affecting the vibration effect of the linear motor 100.

Please refer to FIGS. 2-8, the vibrator component 20 also includes counterweights 24 fixed on the clamp plate 23 and set at two ends relative to the magnet component 21. The counterweights 24 can provide a greater weight to the vibrator component 20, increasing the vibration of linear motor 100. The counterweights 24 include a first portion 241 located outside the cavity 231 and a second portion 242 accommodated inside the cavity 231. The first portion 241 does not contact the sleeve 331, the clamp plate 23 abuts against the first portion 241, and the second portion 242 has a groove 2421 on its surface connected to the clamp plate 23, and the groove 2421 interlocks with the protrusion 232 set on the clamp plate 23.

Furthermore, please refer to FIGS. 2 and 3, the magnet component 21 also includes a soft magnetic body 22 arranged at intervals along the first direction X, with the number of soft magnetic bodies 22 being one less than the number of magnets 211 and the soft magnetic bodies 22 being respectively set between two adjacent magnets 211. By setting the soft magnetic bodies 22 between two adjacent magnets 211, the magnetic field can be enhanced to increase the vibration performance of linear motor 100.

The soft magnetic body 22 includes a first soft magnetic body 221 corresponding to the auxiliary magnet component 31, and a second soft magnetic body 222 set corresponding to the coil unit 32, the first soft magnetic body 221 is spaced opposite the auxiliary magnet component 31, and the second soft magnetic body 222 is spaced opposite the coil unit 32.

The soft magnetic body 22 is made of soft magnetic body. As an illustrative example, the soft magnetic body can be carbon steel material, or, the soft magnetic body can be iron-cobalt alloy, or, the soft magnetic body can be amorphous alloy, or, the soft magnetic body can be nanocrystalline alloy, or, the soft magnetic body can also be other soft magnetic bodies.

It should be noted that the auxiliary magnet component 31 and the magnet component 21 are permanent magnetic materials, with strong magnetic performance, good stability, long service life, and high efficiency and energy saving. Among them, permanent magnetic materials can be neodymium iron boron materials. It can be understood that permanent magnetic materials can also be other permanent magnetic materials, which will not be elaborated here.

Specifically, the magnet component 21 is magnetized as a whole, i.e., magnetized at different positions on an integral soft magnetic body to form magnet 211, which can simplify the assembly process and improve production efficiency. Alternatively, the magnet component 21 is magnetized individually, where each magnet 211 is magnetized separately and then bonded and fixed to the soft magnetic body 22, providing high flexibility for maintenance and part replacement.

It is understood that the quantity and dimensions of magnet components 21 and coil unit 32 can be determined according to the size of linear motor 100, and the quantity and dimensions of magnet components 21 and coil unit 32 can be increased or decreased according to specific situations.

Compared with related technologies, this invention consists of an auxiliary magnet component and a magnetic spring composed of two magnet steel components set in parallel with opposite magnetization directions. The magnetic repulsion between the auxiliary magnet component and the magnet steel provides effective restoring force for the vibrator component, ensuring that the vibrator component can move back and forth along the first direction. This not only solves the issue of deformation stress of traditional spring materials, but also improves the service life of linear motors. In addition, the auxiliary magnet component does not occupy the design size of the first direction, allowing for a larger motion range of the vibrator component, resulting in greater vibration amplitude and improved vibration performance and reliability.

The foregoing is merely illustrative of embodiments of the present invention, and it should be noted that modifications may be made to those skilled in the art without departing from the spirit of the invention but are intended to be within the scope of the invention.

What is claimed is:

1. A linear motor comprising:
a housing with an accommodating cavity;
a stator component accommodated in the accommodating cavity, the stator component comprising a guiding member fixed to the housing for supporting the vibrator component, and a coil unit for driving the vibrator component to reciprocate in a first direction;
a vibrator component received in the accommodating cavity, the vibrator component comprising a magnet component arranged along the first direction, the magnet component comprising at least two magnets arranged along the first direction, each of the magnets being magnetized along the first direction and magnetization directions of adjacent two magnets being opposite to each other; wherein
the stator component further comprises an auxiliary magnet component positioned near to adjacent ends of the at least two adjacent magnets; the auxiliary magnet component is magnetized along a second direction perpendicular to the first direction and forms magnetic repulsion with the corresponding the at least two magnets.

2. The linear motor as described in claim 1, wherein the auxiliary magnet component comprises a pair of auxiliary magnets magnetized along the second direction and arranged on opposite sides of the vibrator component for forming magnetic repulsion with the at least two magnets; or, the auxiliary magnet components comprise two pairs of auxiliary magnets magnetized along the second direction and arranged on opposite sides of the vibrator component, for forming magnetic repulsion with the at least two magnets; or, the auxiliary magnet component is an annular magnet, with the second direction being radial to the annular magnet for forming a magnetic repulsion with the at least two magnets.

3. The linear motor as described in claim 1, wherein the coil unit locates around the adjacent ends of the at least two adjacent magnets, and the coil unit is arranged on one side or both sides of the auxiliary magnet components along the first direction.

4. The linear motor as described in claim 1, wherein the guiding member comprises two sleeves arranged along the first direction at two ends of the vibrator component, the sleeve includes a guiding channel passing therethrough, and the vibrator component is accommodated in the guiding channel and slidably connected to the sleeves.

5. The linear motor as described in claim 4, wherein the vibrator component further includes a clamp plate sleeved in the guide sleeve with a cavity, the magnet component is fixed on the clamp plate and accommodated in the cavity, and the clamp plate is slidably connected with the guide sleeve.

6. The linear motor as described in claim 5, wherein the guide sleeve further has an avoidance groove for avoiding an edge of the clamp plate.

7. The linear motor as described in claim 5, wherein the vibrator component further comprises counterweights fixed to the clamp plate and positioned at opposite ends of the magnet component; the counterweight includes a first portion located outside the accommodating cavity and a second portion inside the accommodating cavity; the first portion does not contact the guide sleeve, and the clamp plate abuts against the first portion; the second portion has a groove on a surface connected to the clamp plate, and the groove engages with the protrusion on the clamp plate.

8. The linear motor as described in claim 3, wherein the magnet components further include at least one soft magnetic body arranged along the first direction and between the at least two magnets, and an amount of the soft magnetic body is one less than an amount of the magnets.

9. The linear motor as described in claim 8, wherein the soft magnetic body comprises a first soft magnetic body corresponding to the auxiliary magnet component and a second soft magnetic body arranged corresponding to the coil unit; the first soft magnetic body is opposite to the auxiliary magnet component, and the second soft magnetic body is opposite to the coil unit.

10. The linear motor as described in claim 8, wherein the soft magnetic body is made of at least one material selected from carbon steel, iron-cobalt alloys, amorphous alloys, or nanocrystalline alloys.
